(19) United States
(12) Patent Application Publication
(10) Pub. No.: US 2009/0127816 A1
(43) Pub. Date: May 21, 2009

(54) Tractor

(76) Inventors: Yozo Oka, Osaka (JP); Nobuaki Takahashi, Osaka (JP); Katsuzo Kato, Osaka (JP)

Correspondence Address: JORDAN AND HAMBURG LLP, 122 EAST 42ND STREET, SUITE 4000, NEW YORK, NY, 10168, US

(21) Appl. No.: 11/991,622

(22) PCT Filed: Jan. 4, 2006
(86) PCT No.: PCT/JP2006/300014

§ 371 Date: Mar. 7, 2008

(30) Foreign Application Priority Data
Sep. 9, 2005 (JP) 2005-262639

(51) Int. Cl. B62D 25/24; B62D 25/22

(52) U.S. Cl. 280/164.1; 280/169

(57) ABSTRACT

The present invention provides a tractor which can easily perform maintenance of a pedal interlocking mechanism. In a tractor which includes a driver portion, a stepped portion mounted on the driver portion in an extending manner, and a pedal interlocking mechanism arranged below the stepped portion, a maintenance-use opening portion is formed in the stepped portion, and the maintenance-use opening portion is closed by an open/close lid body in an openable manner. Due to such a constitution, In maintaining the pedal link mechanism, the lid is opened to expose the opening so that the pedal link mechanism can be easily maintained through the maintenance-use opening from above the stepped portion.

### BACKGROUND OF THE INVENTION

1. Field of the Invention

The present invention relates to a tractor which forms a maintenance-use opening portion in a stepped portion of a driver portion.

2. Description of Related Art

Conventionally, as one mode of a tractor, there has been known a tractor in which a stepped portion is mounted on a driver portion in an extending manner, an operator can get on and off the driver portion by way of the stepped portion, and the operator can stand firm by his/her foot at the time of operating the tractor (for example, see patent document 1).

Further, there has been known a tractor in which a pedal interlocking mechanism which is interlockingly connected to a brake pedal and a clutch pedal mounted on the driver portion is arranged in a space defined below the stepped portion.

However, in the above-mentioned tractor, the pedal interlocking mechanism is arranged in the space below the stepped portion and hence, there exists a drawback that, in performing maintenance of the pedal interlocking mechanism, an operator has to perform the maintenance by getting under the stepped portion thus making the maintenance difficult.

### Patent Document 1: Japanese Patent Laid-open Hei6(1994)-286526

### SUMMARY OF THE INVENTION

(1) According to a first aspect of the present invention, a tractor includes a driver portion, a stepped portion mounted on the driver portion in an extending manner, and a pedal interlocking mechanism arranged below the stepped portion, wherein a maintenance-use opening portion is formed in the stepped portion, and the maintenance-use opening portion is closed by an open/close lid body in an openable manner.

According to the present invention, the maintenance-use opening portion is formed in the stepped portion and is closed in an openable manner using the open/close lid body and hence, in performing the maintenance of the pedal interlocking mechanism, by exposing the maintenance-use opening portion by opening the open/close lid body, it is possible to easily perform the maintenance of the pedal interlocking mechanism through the maintenance-use opening portion from above the stepped portion.

(2) According to a second aspect of the present invention, the maintenance-use opening portion is arranged at a position of the stepped portion where an operator sitting on the driver portion puts on his/her foot, and a non-slip portion is formed on the open/close lid body which closes the maintenance-use opening portion.

According to the present invention, the maintenance-use opening portion is arranged at the position of the stepped portion where the operator sitting on the driver portion puts on his/her foot and hence, the maintenance-use opening portion is closed by the open/close lid body on which the non-slip portion is formed whereby the operator can stand firm surely by his/her foot putted on the open/close lid body by way of the non-slip portion.

As a result, it is possible to enhance the operability and the comfortableness in the driver portion.

(3) According to a third aspect of the present invention, the working oil tank is arranged below the stepped portion, and an oil filling port formed in the working oil tank is configured to allow an oil filling operation from above the stepped portion through the maintenance-use opening portion opened by exposing the open/close lid body.

According to the present invention, the oil filling port of the working oil tank arranged below the stepped portion is configured to allow an oil filling operation from above the stepped portion through the maintenance-use opening portion opened by exposing the open/close lid body and hence, an operator can rapidly and surely perform an oil filling operation with a comfortable posture.

### BRIEF DESCRIPTION OF THE DRAWINGS

FIG. 1 is a side view of a tractor according to the present invention;

FIG. 2 is a plan view of the tractor;

FIG. 3 is a side view of a prime mover part and a driver portion of the tractor;

FIG. 4 is a planar explanatory view of a left stepped portion;

FIG. 5 is a cross-sectional back view of the left stepped portion; and

FIG. 6 is an explanatory perspective view of an oil pressure pipe.

### DESCRIPTION OF THE PREFERRED EMBODIMENT

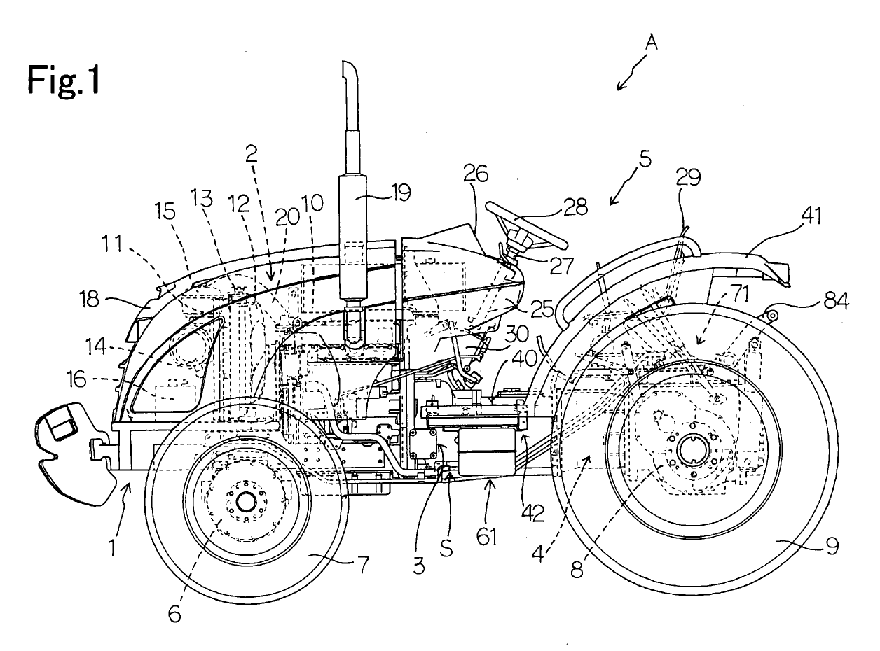

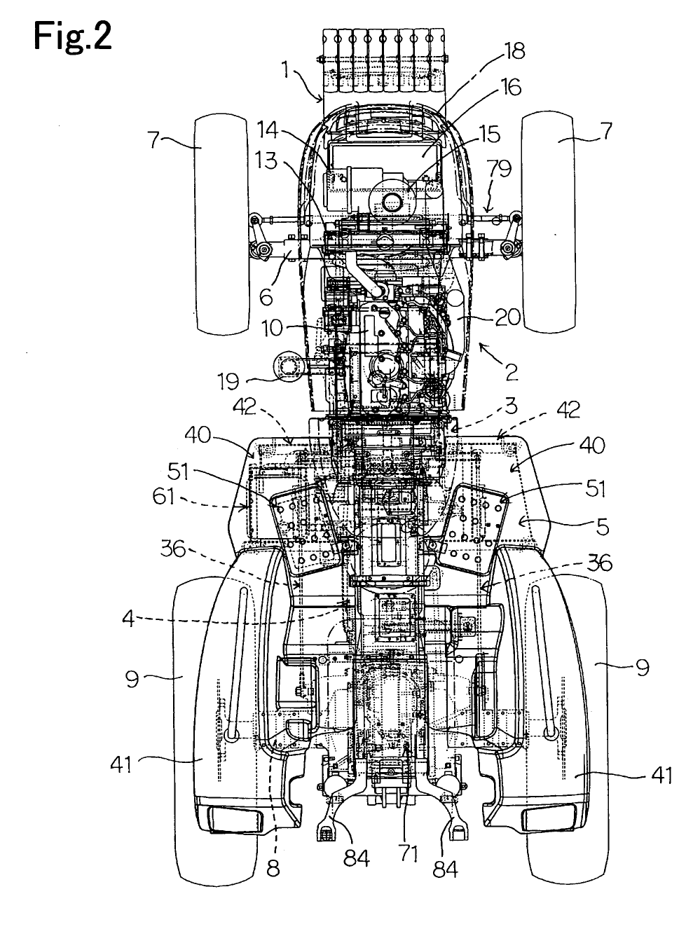

Symbol A shown in FIG. 1 and FIG. 2 indicates a tractor according to the present invention. In the tractor A, a prime mover part 2 is mounted on a body frame 1, a transmission portion 4 is interlockingly connected to the prime mover part 2 by way of a clutch portion 3, a driver portion 5 is arranged on the transmission portion 4, a pair of left and right front wheels 7, 7 are interlockingly connected to a lower portion of the body frame 1 by way of a front axle case 6, and a pair of left and right rear wheels 9, 9 are interlockingly connected to the transmission portion 4 by way of rear axle cases 8, 8.

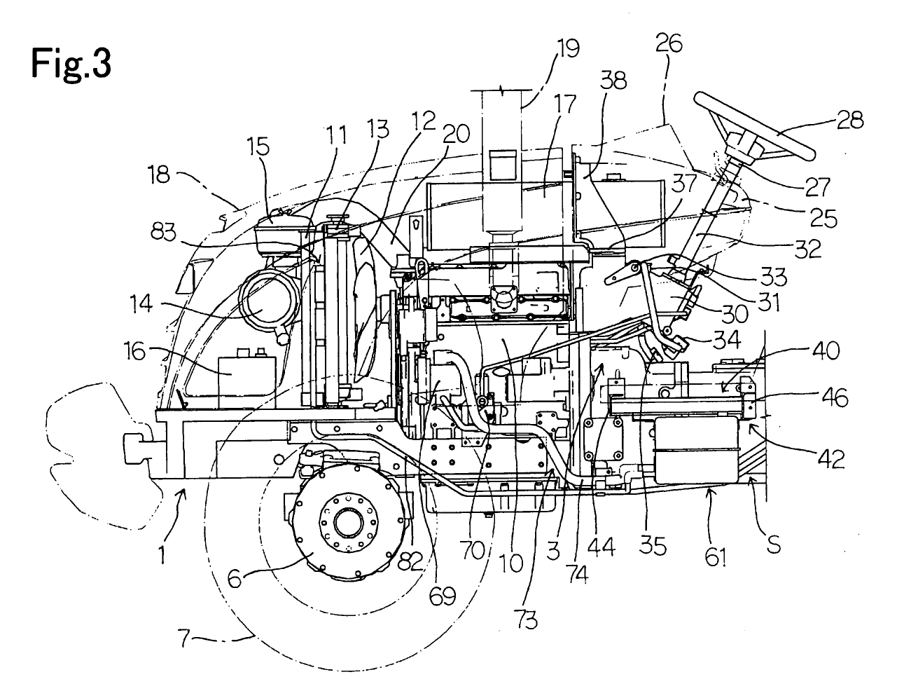

In the prime mover part 2, also as shown in FIG. 3, an engine 10 is mounted on the body frame 1, a radiator 13 including an outside-air suction fan 12 is arranged at a position directly in front of the engine 10 by way of a support frame body 11, an air cleaner 14 is arranged at a position directly in front of the radiator 13 by way of the support frame body 11, a precleaner 15 is arranged at a position directly above the air cleaner 14, a battery 16 is arranged at a position directly below the air cleaner 14, and a fuel tank 17 formed in the longitudinally extending manner is arranged at a position directly above the engine 10. These portions are covered with a bonnet 18 in an openable manner. Numeral 19 indicates a muffler, and numeral 20 indicates an air supply pipe.

Due to such a constitution, in the prime mover part 2, it is possible to cool the radiator 13 by sucking outside air using the outside-air suction fan 12 through a front grille portion described later mounted on the bonnet 18.

In the driver portion 5, as shown in FIG. 1 to FIG. 3, a dashboard 25 is arranged to close a rear end opening portion of the bonnet 18 mounted on the prime mover part 2, a meter panel 26 is mounted on an upper surface portion of the dashboard 25, a steering wheel support shaft 27 projects upwardly from a rear position of the meter panel 26, a steering wheel 28 is mounted on an upper end portion of the steering wheel support shaft 27, and a driver seat 29 is arranged behind the steering wheel 28 and directly above the transmission portion 4.

Here, on a rear wall of the engine 10, as shown in FIG. 3, a dashboard stay 30 supporting the dashboard 25 is mounted, and a pedal support member 31 and a steering shaft support member 32 are mounted on the dashboard stay 30.

Further, a pedal support shaft 33 extending in the lateral direction is mounted on the pedal support member 31, and a clutch pedal 34 is mounted on a left end portion of the pedal support shaft 33 and, on the other hand, left and right brake pedals 35, 35 are mounted on a right end portion of the pedal support shaft 33.

Further, as shown in FIG. 2, the left and right brake pedals 35, 35 are interlockingly connected to left and right brake devices (not shown in the drawing) incorporated in the transmission portion 4 by way of left and right pedal interlocking mechanisms 36, 36, and the left and right pedal interlocking mechanisms 36, 36 are arranged below left and right stepped portions 40, 40 which extend from the driver portion 5 described later.

Further, a fuel tank stay 37 for supporting the fuel tank 17 is mounted on the dashboard stay 30, and a bonnet stay 38 for supporting the bonnet 18 is mounted on the fuel tank stay 37.

As shown in FIG. 2 and FIG. 3, the left and right stepped portions 40, 40 of the driver portion 5 are formed on left and right portions of a front portion of the transmission portion 4 in a state that the left and right stepped portions 40, 40 project outwardly. Further, a pair of left and right fender portions 41, 41 extends from rear end peripheral portions of the stepped portions 40, 40 in a state that the left and right fender portions 41, 41 cover the left and right rear wheels 9, 9 from a front side and above.

Here, as shown in FIG. 2 and FIG. 3, the left and right stepped portions 40, 40 are supported on left and right stepped-portion support frame bodies 42, 42 which constitute stepped-portion support bodies mounted on left and right side walls of the transmission portion 4 in a projecting manner.

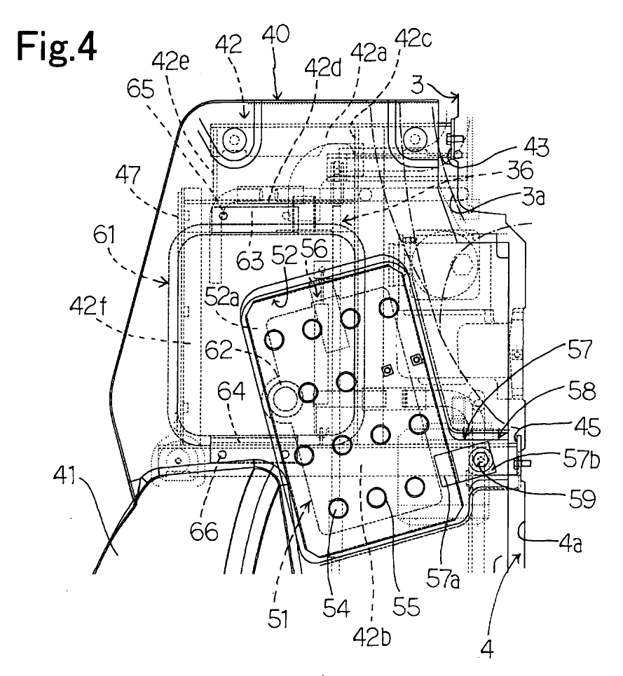

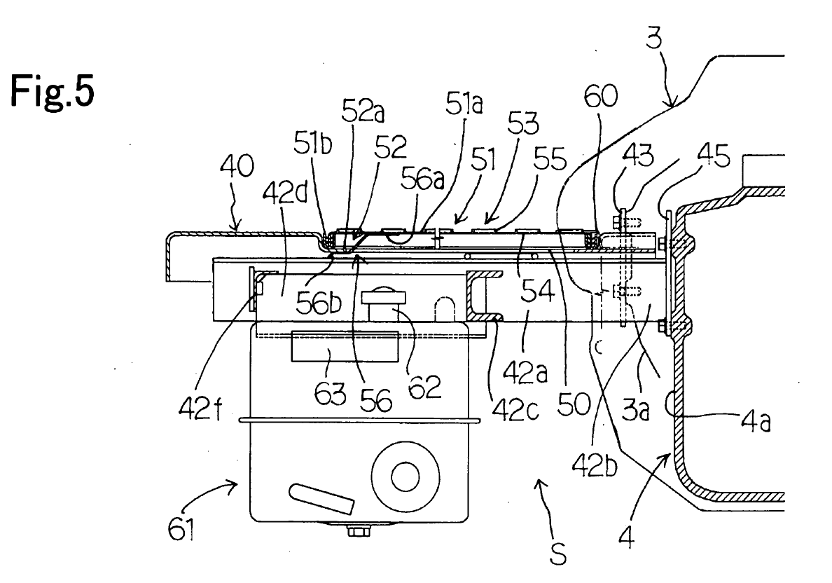

Further, also as shown in FIG. 4 and FIG. 5, the left stepped-portion support frame body 42 is assembled and formed into a frame as follows. A proximal end portion (right end portion) of a front laterally-extended member 42a extending in the lateral direction is mounted on a left side wall 3a of the clutch portion 3 by way of a front mounting bracket 43, while a proximal end portion (right end portion) of a rear laterally-extended member 42b extending in the lateral direction is mounted on a left side wall 4a of the transmission portion 4 by way of a rear mounting bracket 45. An inner longitudinally-extended member 42c extending in the longitudinal direction is extended between intermediate portions of both the front and rear support-frame forming members 42a, 42b. An intermediate laterally-extended member 42d extends outwardly from a front portion of the inner longitudinally-extended member 42c. An intermediate longitudinally-extended member 42e is extended between an outer portion of the intermediate laterally-extended member 42d and an outer end portion of the front laterally-extended member 42a. An outer longitudinally-extended member 42f is extended between an outer end portion of the intermediate laterally-extended member 42d and an outer end portion of the rear laterally-extended member 42b. Here, the right stepped-portion support frame body 42 is also constituted in the same manner as described above.

Further, as shown in FIG. 5, the left and right stepped portions 40, 40 respectively form left and right maintenance-use opening portions 50, 50 therein, and the left and right maintenance-use opening portions 50, 50 are closed by open/close lid bodies 51, 51 in an openable manner.

That is, as shown in FIG. 4 and FIG. 5, a rectangular stepped recessed portion 52 extending in the left outward direction is formed on a left stepped portion 40, a rectangular left maintenance-use opening portion 50 extending in the left outward direction is opened in a bottom portion of the stepped recessed portion 52, and the left maintenance-use opening portion 50 is arranged at a position where the operator sitting on the driver seat 29 of the driver portion 5 puts on his foot.

Further, the open/close lid body 51 is formed of a lid body 51a which is formed in a rectangular shape substantially equal to a shape of the left maintenance-use opening portion 50 and a support leg body 51b extending in the downward direction from a peripheral portion of the lid body 51a.

On the lid body 51a, a large number of non-slip portions 53 are orderly arranged in the longitudinal direction and in the lateral direction, and the non-slip portion 53 is constituted of a circular mud scraping hole 54 and a mud scraping member 55 raised from a peripheral portion of the mud scraping hole 54 by cutting and also functions as a non-slip member.

Further, a proximal end portion 56a of an engaging member 56 is mounted on a front portion of a bottom surface of the lid body 51a, while a distal end portion 56b of the engaging member 56 extends in the frontward and downward direction. The distal end portion 56b of the engaging member 56 is engageable with the peripheral portion 52a of the bottom portion of the stepped recessed portion 52 from below.

Further, a proximal end portion 57a of a fixing member 57 is mounted on a right rear portion of an upper surface of the lid body 51a, while a distal end portion 57b of the fixing member 57 extends in the right outward direction. A bolt insertion hole (not shown in the drawing) is formed in the distal end portion 57b.

On the other hand, a stepped-and-recessed extending portion 58 extending in the rightward direction is formed on a right rear portion of the stepped recessed portion 52, a bolt hole (not shown in the drawing) aligned with the bolt insertion hole is formed in the stepped-and-recessed extending portion 58. By inserting a fixing bolt 59 into both holes and threadedly engaging the fixing bolt 59 to a nut, the distal end portion 57b of the fixing member 57 is detachably fixed to the left stepped portion 40 in the inside of the stepped recessed extending portion 58.

A vibration-and-sound-proofing cushion member 60 is mounted on the support leg body 51b in a state that the cushion member 60 is arranged along a periphery of the support leg member 51, and the support leg body 51b is mounted on the peripheral portion 52a of the bottom portion of the stepped recessed portion 52 by way of the cushion member 60. Due to such a constitution, it is possible to close the left maintenance-use opening portion 50 using the lid body 51a.

Here, the lid body 51a is configured such that an upper surface of the lid body 51a is formed substantially coplanar with the upper surface of the left stepped portion 40 in a state that the opening portion 50 is closed by the lid body 51a. The mud scraping member 55 which also functions as a non-slip member is configured to slightly project upwardly from the upper surface of the left stepped portion 40.

Here, the right stepped portion 40 and the right maintenance-use opening portion 50 are also constituted in the same manner as the above-mentioned left stepped portion 40 and the left maintenance-use opening portion 50.

As described above, the left and right maintenance-use opening portions 50, 50 are formed in the left and right stepped portions 40, 40, and the respective maintenance-use opening portions 50, 50 are closed by the open/close lid bodies 51, 51 in an openable manner. Accordingly, in performing the maintenance of the left and right pedal interlocking mechanisms 36, 36 arranged below the left and right stepped portions 40, 40, by opening the respective open/close lid bodies 51, 51, the respective maintenance-use opening portions 50, 50 are opened or exposed. Accordingly, it is possible to easily perform the maintenance of the respective pedal interlocking mechanisms 36, 36 through the respective maintenance-use opening portions 50, 50 from above the respective stepped portions 40, 40.

Here, the open/close lid body 51 engages the distal end portion 56b of the engaging member 56 with the peripheral portion 52a of the bottom portion of the stepped recessed portion 52 from below, while the bolt insertion hole formed in the distal end portion 57b of the fixing member 57 is aligned with the bolt hole formed in the stepped-and-recessed extending portion 58. By inserting the fixing bolt 59 into both holes and threadedly engaging the fixing bolt 59 to a nut, it is possible to fix the distal end portion 57b of the fixing member 57 to the left stepped portion 40 in the inside of the stepped recessed extending portion 58.

Further, in removing the respective open/close lid bodies 51 from the respective stepped portions 40, by performing the above-mentioned steps in a reverse manner, the open/close lid bodies 51 can be easily removed from the stepped portions 40.

Accordingly, the respective open/close lid bodies 51 can be easily and surely mounted on and removed from the respective stepped portions 40.

Further, the respective maintenance-use opening portions 50 are arranged at positions where the operator sitting on the driver seat 29 of the driver portion 5 puts on his foot and, at the same time, a large number of non-slip portions 53 are formed on open/close lid bodies 51 which close the respective maintenance-use opening portions 50. Accordingly, the operator can stand firm with the his/her foots putted on the open/close lid bodies 51 by way of the non-slip portions 53 whereby the operability and the comfortableness at the driver portion 5 can be enhanced.

Here, the non-slip portion 53 is constituted of the circular mud scraping hole 54 and the mud scraping member 55 which is raised from the peripheral portion of the mud scraping hole 54 by cutting and also functions as a non-slip member. Accordingly, the mud scraping member 55 which also functions as a non-slip member imparts a slip preventing function to an operator's shoes and, at the same time, performs a mud scraping function for scraping mud or the like adhered to soles of the shoes of the operator and hence, the scraped mud or the like is cast onto a farm field through the circular mud scraping hole 54.

Further, in this embodiment, a working oil tank 61 is arranged below the left stepped portion 40, while an oil filling port 62 formed in an upper portion of the working oil tank 61 is configured to allow an oil filling operation from above the left stepped portion 40 through the maintenance-use opening portion 50 opened by removing the open/close lid body 51.

That is, the working oil tank 61 is detachably extended between the intermediate laterally-extending member 42b and the rear laterally-extending member 42b of the left stepped-portion support frame body 42 supporting the left stepped portion 40 by way of the front and rear mounting brackets 63, 64. Numerals 65, 66 indicate mounting-use bolts.

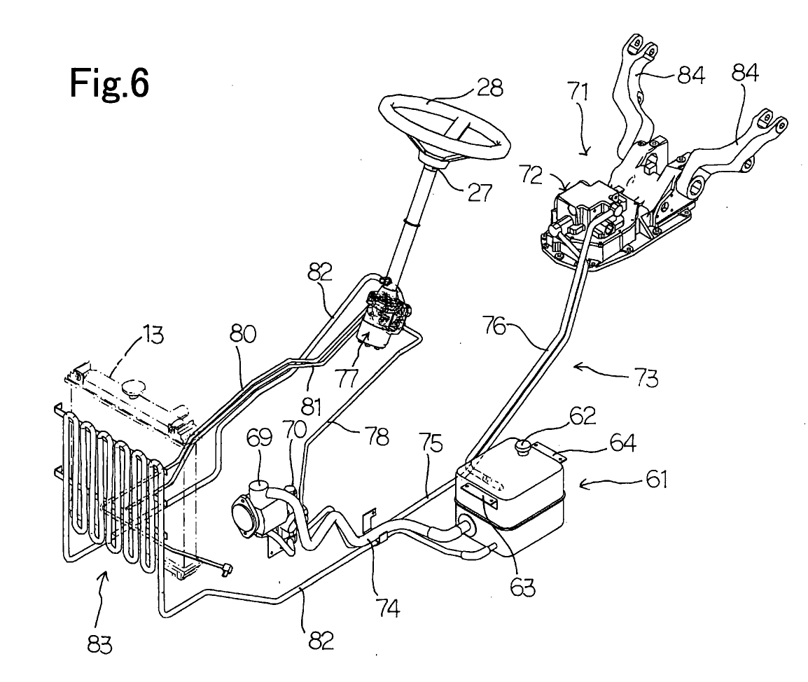

Further, as shown in FIG. 1 and FIG. 6, the working oil tank 61 is arranged at a longitudinally intermediate position between a working oil pump 69 interlockingly connected to a left-side front portion of the prime mover part 2 and an hydraulic circuit body 72 which constitutes a portion of a lifting mechanism 71 mounted on a rear portion of the transmission portion 4. Numeral 84 indicates a lift arm constituting a portion of the lifting mechanism 71.

As described above, in the oil filling port 62 of the working oil tank 61 arranged below the left stepped portion 40, oil can be filled from above the left stepped portion 40 through the maintenance-use opening portion 50 opened by removing the open/close lid body 51. Accordingly, an oil filling operator can rapidly and accurately perform an oil filling operation with a comfortable posture.

Further, the working oil tank 61 is arranged in the inside of a space S which is a dead space defined below the left stepped portion 40 mounted on the driver portion 5 in an extending manner. Accordingly, it is possible to effectively make use of the space S thus ensuring the excellent assembly and the excellent maintenance of the machine body.

Still further, the working oil tank 61 is mounted on the left stepped-portion supporting frame body 42 and hence, it is unnecessary to additionally provide a member for mounting the working oil tank 61 on the left stepped-portion supporting frame body 42 thus realizing the reduction of the number of parts and the reduction of the manufacturing cost.

Further, the working oil tank 61 is arranged at the longitudinally intermediate position between the working oil pump 69 and the hydraulic circuit body 72. Accordingly, by communicably connecting the working oil pump 69, the hydraulic circuit body 72 and the working oil tank 61 with each other, an oil pressure pipe 73 can be shortened as much as possible and, at the same time, the oil pressure pipe 73 can be easily arranged around the machine body.

Next, the explanation is made with respect to the above-mentioned oil pressure pipe 73 in conjunction with FIG. 1 and FIG. 6.

That is, the oil pressure pipe 73 is constituted of a supply pipe 74 which supplies the working oil to the working oil pump 69 from the working oil tank 61, a lifting-use feed pipe 75 which supplies the working oil to the hydraulic circuit body 72 from the working oil pump 69 at a high-pressure through a distributor 70 mounted on a left side wall of the engine 10, a lifting-use return pipe 76 which returns the working oil to the working oil tank 61 from the hydraulic circuit body 72 at a low pressure, a power-steering-use feed pipe 78 which supplies the working oil to a power-steering-use valve 77 interlockingly connected to a lower end portion of the steering wheel support shaft 27 from the working oil pump 69 by way of the distributor 70 at a high pressure, a cylinder feed pipe 80 which supplies the working oil to a power-steering-use cylinder (not shown in the drawing) of a power steering mechanism 79 (see FIG. 2) interposed between the left and right front wheels 7, 7 at a high-pressure, a cylinder return pipe 81 which returns the working oil to the power-steering-use valve 77 from the power-steering-use cylinder at a low pressure, and a power-steering-use return pipe 82 which returns the working oil to the working oil tank 61 from the power-steering-use valve 77 at a low pressure.

Further, as shown in FIG. 3 and FIG. 6, an oil cooler portion 83 is provided to a midst portion of the power-steering-use return pipe 82, and the oil cooler portion 83 is arranged directly in front of the radiator 13 in a zigzag manner in the vertical direction along a front surface of the radiator 13. The oil cooler portion 83 is supported on the support frame body 11.

Due to such a constitution, by allowing a cooling wind for cooling the radiator 13 also to impinge on the oil cooler portion 83, it is possible to cool the working oil which flows in the inside of the oil cooler portion 83 and, thereafter, returns to the working oil tank 61.

The structure of the tractor according to the present invention is applicable to the structure in which the pedal interlocking mechanism is arranged below the stepped portion mounted on the driver portion in an extending manner.

What is claimed is:

1. A tractor comprising:
a driver portion;
a stepped portion mounted on the driver portion in an extending manner; and
a pedal interlocking mechanism arranged below the stepped portion; wherein
a maintenance-use opening portion is formed in the stepped portion, and the maintenance-use opening portion is closed by an open/close lid body in an openable manner.

2. A tractor according to claim 1, wherein the maintenance-use opening portion is arranged at a position of the stepped portion where an operator sitting on the driver portion puts on his/her foot, and a non-slip portion is formed on the open/close lid body which closes the maintenance-use opening portion.

3. A tractor according to claim 1, wherein the working oil tank is arranged below the stepped portion, and an oil filling port formed in the working oil tank is configured to allow an oil filling operation from above the stepped portion through the maintenance-use opening portion opened by exposing the open/close lid body.
